(19) United States
(12) Patent Application Publication
(10) Pub. No.: US 2005/0131595 A1
(43) Pub. Date: Jun. 16, 2005

(54) Enhanced vehicle event information

(76) Inventors: Eugene Luskin, Issaquah, WA (US); Andrew Petrochuk, Bellevue, WA (US); David Kizhnerman, Kirkland, WA (US)

Correspondence Address: LEE & HAYES PLLC, 421 W RIVERSIDE AVENUE SUITE 500, SPOKANE, WA, 99201, US

(21) Appl. No.: 10/735,382

(22) Filed: Dec. 12, 2003

(51) Int. Cl. G06F 7/00

(52) U.S. Cl. 701/29; 701/33

(57) ABSTRACT

A method includes generating an explanation of a vehicle condition based on a vehicle diagnostics code. The explanation may include a textual, graphical, audio, or other user-friendly explanation of the vehicle diagnostics code. Supplemental information related to the vehicle diagnostics code may also be generated. A vehicle includes a vehicle-based computer for generating an explanation of a vehicle condition corresponding to a vehicle diagnostics code. The vehicle-based computer may communicate the explanation over a network.

### CROSS-REFERENCE TO RELATED APPLICATIONS

The present application is related to concurrently filed U.S. patent application Ser. No. ______ entitled “SMART VEHICLE VIDEO MANAGEMENT”, and U.S. patent application Ser. No. ______ entitled “REMOTE VEHICLE SYSTEM MANAGEMENT”, both of which are assigned to the Assignee of the present application.

### TECHNICAL FIELD

The described subject matter relates to vehicle systems. More particularly, the subject matter relates to enhanced vehicle event information.

### BACKGROUND

Automobiles and other vehicles typically have onboard diagnostics (OBD) systems that record occurrences of certain conditions in the vehicles. OBD systems assist technicians in diagnosing problems in vehicle engines. When an engine system is found to be operating out of specification, the OBD system stores a fault code in an onboard computer. Later, a technician can read the stored fault codes with an OBD reader to determine problems with the vehicle engine. In some cases, a warning light (e.g., “check engine”) illuminates, indicating an urgent fault. Unfortunately, the average vehicle owner neither has access to, nor understands the meaning of OBD fault codes and, thus, cannot make good judgments regarding the diagnosis of faults or repairs.

Typically a vehicle owner will bring the vehicle into a mechanic to fix a problem after the vehicle exhibits symptoms or a warning light illuminates. The mechanic connects an OBD reader to a diagnostic link connector (DLC), through which the previously recorded OBD fault codes are downloaded. A fault code, such as ‘P0530’, is displayed on the reader. The mechanic then consults an OBD manual that identifies the fault code and describes what component(s) may be associated with the fault code. This process of bringing the car to the mechanic, connecting an OBD reader, downloading the codes, and consulting a manual is time consuming. In addition, the process may be very expensive to the owner, even if the OBD fault codes indicate no problem, or a very minor problem.

The vehicle owner is often not an expert in vehicle engines. The OBD faults codes are cryptic and not readily understandable. A typical vehicle owner does not have an OBD reader or OBD manual to download and identify OBD fault codes. As such, the vehicle owner has no way of validating any diagnosis a mechanic makes. In addition, the vehicle owner visits the mechanic with very little a priori information about the reason for the symptoms or warning light or the cost of any required repairs. The owner may bring the vehicle to the mechanic for a seemingly urgent problem, when in actuality, the problem is not urgent. Thus, there is a need for the ability of a vehicle owner to obtain information from OBD fault codes independently from a mechanic, or without requiring a mechanic's assistance.

### SUMMARY

Implementations of systems and methods described and claimed herein solve the discussed problems, and other problems, by providing enhanced vehicle event information. A vehicle-based computer receives a vehicle diagnostics code and generates an associated explanation of the code. The explanation can be a user-friendly description of the code. The explanation can include supplementary information about repairing the condition related to the code.

An implementation of a method includes generating an explanation of a vehicle condition based on a vehicle diagnostics code. The generating operation may include generating a textual explanation of the vehicle condition. The generating operation may include generating a graphical illustration of a component associated with the vehicle condition. The method may further comprise generating supplemental information related to the vehicle condition. The method may further comprise presenting the explanation at a client, wherein the client may be a local, vehicle-based client or a remote client.

An implementation of a vehicle includes a vehicle-based computer generating an explanation of a vehicle condition based on a vehicle diagnostics code. The explanation may comprise a textual explanation and/or a graphical illustration of a component related to the vehicle condition. The vehicle-based computer may further generate supplemental information related to the vehicle condition, the supplemental information including an estimated price for repair or a location of the closest vehicle dealership. The vehicle may further include a display device presenting the explanation of the vehicle condition. The vehicle-based computer may further include a network communications module transmitting the explanation to a remote computer.

An implementation of a vehicle-based system includes a computer generating an explanation of a vehicle condition indicated by a vehicle diagnostics code. The explanation may comprise a textual explanation and/or a graphical illustration of a component related to the vehicle condition. The vehicle-based computer may further generate supplemental information related to the vehicle condition, the supplemental information including an estimated price for repair or a location of the closest vehicle dealership. The vehicle may further include a display device presenting the explanation of the vehicle condition. The vehicle-based computer may further include a network communications module transmitting the explanation to a remote computer.

An implementation of a data structure stored on a computer-readable medium includes a vehicle diagnostics code field storing a vehicle diagnostics code corresponding to a vehicle condition and an explanation field storing a reference to an explanation of the vehicle condition. The data structure may further include a timestamp field storing the time when the vehicle diagnostics code was generated, a type field storing a vehicle diagnostics code type, a severity field storing a severity level of the vehicle condition, and a component field storing a component identifier corresponding to the vehicle condition. The data structure may be configurable, updateable, and/or extensible.

An implementation of a computer program product provides a computer program storage medium readable by a computer system and encoding a computer program for generating an explanation of a vehicle condition corresponding to a vehicle diagnostics code. The generating operation may include generating a textual explanation of the vehicle condition. The generating operation may include generating a graphical illustration of a component associated with the vehicle condition. The method may further comprise generating supplemental information related to the vehicle condition. The method may further comprise presenting the explanation at a client, wherein the client may be a local, vehicle-based client or a remote client.

### BRIEF DESCRIPTION OF THE DRAWINGS

FIG. 1 illustrates an exemplary operating environment in which a remote vehicle computer management scheme may be employed.

FIG. 2 illustrates a plan view of a vehicle operable to employ remote vehicle computer management.

FIG. 3 illustrates a block diagram of an exemplary vehicle-based computer system that enables remote vehicle computer management.

FIG. 4 illustrates an exemplary arrangement of vehicle systems, vehicle system data, and a relational database application that can collect and relate vehicle system data.

FIG. 5 illustrates an arrangement of vehicle system data referencing a diagnostics explanation store that may be used for event based vehicle assistance.

FIG. 6 illustrates an exemplary explanation of a vehicle diagnostics code in a windowed display.

FIG. 7 illustrates a flowchart having exemplary operations for remotely managing one or more vehicle computer systems.

FIG. 8 illustrates a flowchart having exemplary operations for remotely configuring data for one or more configurable vehicle computer systems.

FIG. 9 illustrates a suitable computer system for generating enhanced vehicle event information.

### DETAILED DESCRIPTION

Overview

Exemplary implementations of methods, systems, devices, computer program products, and data structures are disclosed for generating enhanced vehicle event information. Traditional systems and methods for analyzing vehicle events, such as diagnostics events, involve an experienced user or professional technician being physically present at the vehicle and creating a physical connection to the vehicle to download cryptic vehicle event codes that were previously stored. The vehicle event codes have traditionally been viewed through user interfaces that are different for each of multiple vehicle systems. Implementations described herein provide for generating enhanced vehicle information related to vehicle-based systems. A vehicle-based computer can generate user-friendly explanations of vehicle conditions and/or vehicle event codes.

Exemplary Operating Environment

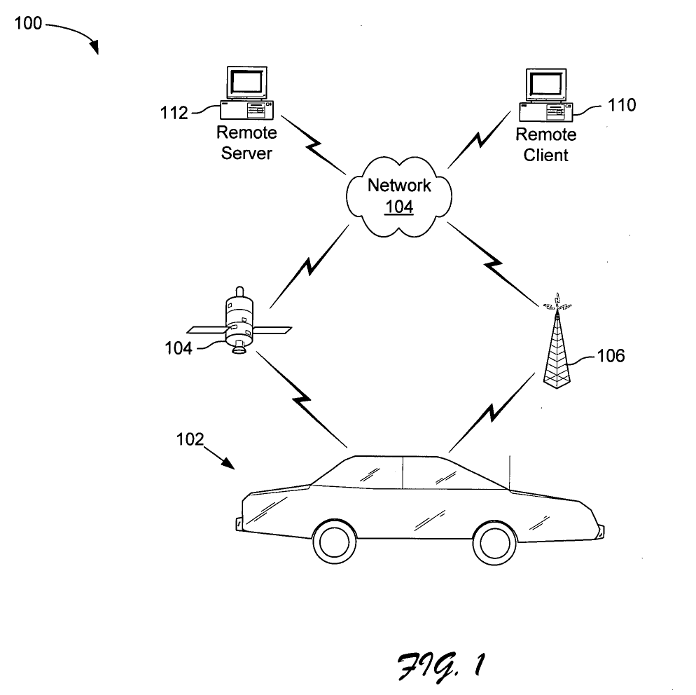

FIG. 1 illustrates an exemplary operating environment 100 in which an enhanced vehicle information scheme may be employed. The environment 100 includes a vehicle 102 that includes one or more vehicle systems. As used herein a vehicle system is any on-board system that provides data about operation of the vehicle. Examples of vehicle systems are control systems, diagnostics systems, entertainment systems, and navigation systems.

A vehicle-based computer (not shown) located within or on the vehicle 102 can communicate data related to the vehicle system(s) over a network 104. As illustrated, the vehicle 102 may communicate with a satellite 106 and/or a cell tower 108, or other wireless network, such as 802.11x, to access the network 104. Via the network 104, the vehicle-based computer can communicate with remote computing devices, such as, but not limited to, a remote client 110 (e.g., a desktop computer) or a remote server computer 112. Thus, via the network 104, the vehicle-based computer can transmit user-friendly explanations of vehicle conditions to remote computing devices.

The network 104 may include a number of interconnected sub-networks. For example, the network 104 may be the Internet. The network 104 may also include a satellite, telephone land-line, or wireless network. The network 104 facilitates communication among computing devices using a communication protocol. Exemplary communication protocols are TCP/IP, HTTP, and SOAP.

Regardless of the particular network 104 or communication protocol used, one or more computer systems in the vehicle 102 can use the network 104 to communicate with the remote server 112 and the remote client 110, as long as the remote server 112 and remote client 110 support the communication protocol. Although illustrated as desktop computers, the remote client 110 and remote server 112 may be implemented with other known computing devices, such as, but not limited to, handheld computers, laptops, cell phones, Personal Digital Assistants (PDAs), or others. Such devices typically include a network application, such as, but not limited to, INTERNET EXPLORER from MICROSOFT Corporation, which enables the devices to transmit and receive data to and from the network 104.

A vehicle-based computer can act as a network server. As such, the vehicle-based computer can generate a browsable network document, such as a web page definition. The browsable network document can include vehicle system data and enhanced vehicle information related to vehicle conditions. The vehicle-based computer can transmit the browsable network document to the remote server 112 or the remote client 110, where the vehicle system data may be browsed. Network applications typically include a browser utility that enables a user of the remote server 112 or remote client 110 to view electronic documents from the network 104. Such browsable documents can include vehicle system data, such as, but not limited to, Global Positioning System (GPS) data, user configuration data, On-Board Diagnostics (OBD) data, and/or enhanced vehicle event information, from systems in the vehicle 102.

The remote client 110 or server 112 may also be enabled to upload data to the vehicle-based computer in the vehicle 102. Data that is uploaded to the vehicle 102 may be used by one or more vehicle systems in the vehicle 102. Such data may include updates, user data, system configurations, or settings. For example, a GPS or mapping system in the vehicle 102 may be updated with the most up-to-date maps of city streets or facilities, etc. As another example, a user of the vehicle 102 can upload music, videos, or other types of media to the vehicle 102. Systems in the vehicle 102 receive and store the uploaded data for use in the vehicle 102.

In addition, the systems in the vehicle 102 can receive requests from the network 104 for particular information from the vehicle 102. For example, a browsable web page from the vehicle 102 may include entry fields in which a user of the remote client 110 can enter a request for a particular type or types of vehicle data, such as GPS data, OBD data, and/or enhanced vehicle event information. As discussed, a vehicle-based computer can generate a browsable network document that includes the requested vehicle data. A vehicle-based computer can combine different data types from different systems in the vehicle 102 to create a more informative presentation of vehicle system data, than may otherwise be possible using each system separately.

An enhanced vehicle information scheme as described herein may be beneficially implemented in most types of mobile vehicles. Thus, the vehicle 102 is not limited to any particular type of vehicle. For example, as shown in FIG. 1, the vehicle 102 may be an automobile. As another example, the vehicle 102 may be a farm tractor. As yet another example, the vehicle 102 may be a grader, a back-hoe, a paver, or other heavy equipment. Other examples of vehicles include boats, airplanes, or helicopters.

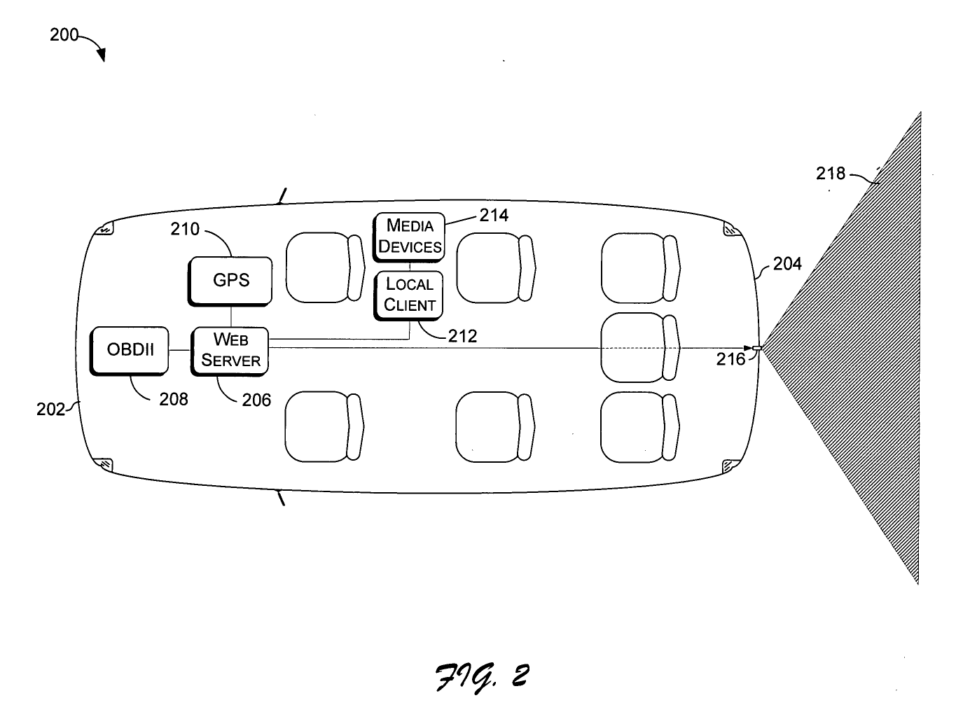

FIG. 2 is a plan view of a vehicle 200 having systems operable to generate enhanced vehicle information based on data from one or more systems in the vehicle 200. The vehicle 200 includes a web server computer 202 that is network enabled for communicating on a network. As such, the server 202 is operable to collect data from one or more vehicle systems and generate browsable network documents including the collected data. In addition, the web server 202 is operable to receive data from a network and store the received data in memory for use by the systems in the vehicle 200.

Exemplary vehicle systems, such as an On-Board Diagnostics II (OBDII) system 204, a GPS 206, and a video camera 208 are installed in the vehicle 200. In an actual implementation, other vehicle systems may be installed. Such systems generate and/or use associated data to facilitate tasks for a driver, other occupants of the vehicle, or remote clients of the web server computer 202. For example, the OBDII system 204 generate error codes or event codes indicative of vehicle conditions that can be presented to the driver of the vehicle, or a mechanic who is remotely logged-in to the web server computer 202.

As another example, the GPS 206 may employ map data that can be downloaded from a network and illustrated to occupants of the vehicle 200. As a further example, video images from the video camera 208 may be presented to occupants of the vehicle 200 or transmitted to a remote client over a network. As shown, the video camera 208 is directed to capture a rear view 210 behind the vehicle 200. In other implementations, the video camera 208 may be directed toward the front or sides of the vehicle 200 to capture other views. While not shown in FIG. 2, other systems, such as obstacle sensors or a vehicle security system, may be installed in or on the vehicle 200 and communicate with the server 202.

A local client 212 can be installed in the vehicle 200 and used by occupants of the vehicle 200. The local client 212 may be a portable computing device, such as a handheld computer, a PDA, a cell phone, or a laptop. The local client 212 may also be mounted in or on the vehicle 200. Media devices 214 include input/output devices through which a vehicle occupant can interact with the local client 212 and/or the web server 202. Exemplary media devices include speakers, printers, and video screens. Thus, for example, a video screen can show a map of the current position of the vehicle 200 from the GPS system 206.

The web server 202 may also utilize media devices for data input/output. Like the client 212, the web server 202 may be a portable device or arranged in a casing or housing that is installed in one of various locations in the vehicle 200. One exemplary housing has a standardized size expressed in terms of Deutsche Industry Normen (DINs). The housing may be installed in the dashboard of the vehicle 200, under a floor board of the vehicle 200, in the trunk of the vehicle 200, or other convenient location, from which the web server 202 may communicate with vehicle systems, as well as local and remote clients.

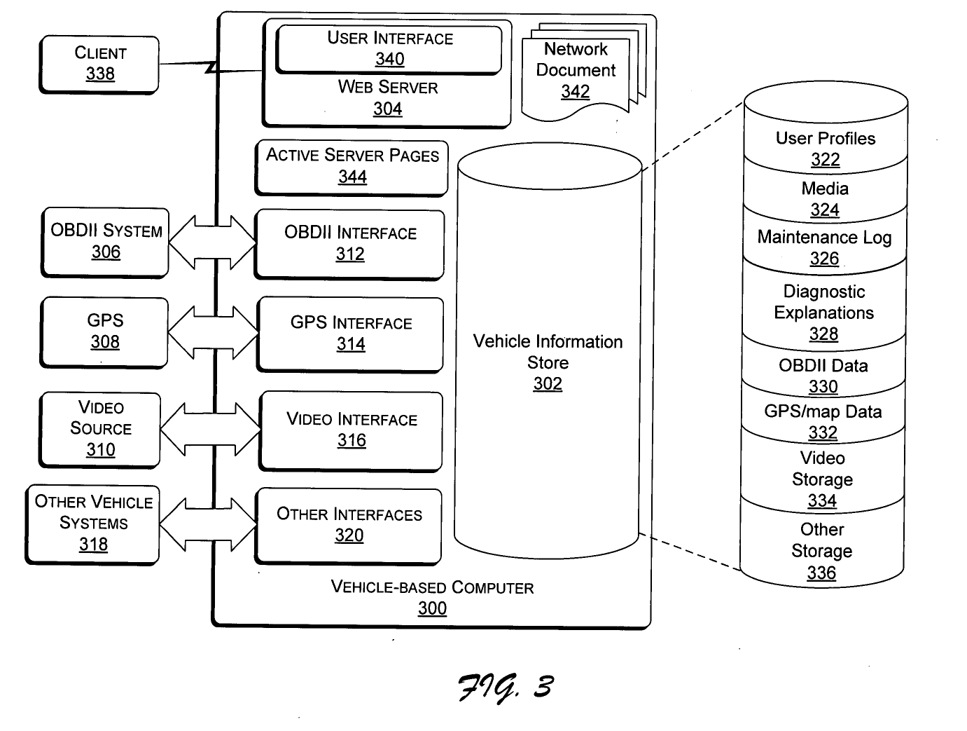

FIG. 3 is a block diagram of an exemplary vehicle-based computer 300 that enables generating enhanced vehicle information related to vehicle conditions. The vehicle-based computer 300 includes one or more vehicle system interfaces for interacting with the vehicle systems. The vehicle-based computer 300 includes computer-readable memory, such as a vehicle information store 302, for storing data associated with the one or more vehicle systems. A server application 304 communicates with the system interfaces to update and upload vehicle system data. Using the interfaces and memories, the server application 304 can retrieve and manage data generated and/or used by the vehicle systems.

In the illustrated implementation, an OBDII system 306, a GPS system 308, and a video source 310, as shown in FIG. 3. In addition to OBD, or rather than OBD, other standard in-vehicle protocols/interfaces could be used, such as a Controller Area Network (CAN) bus, SMART, etc. The OBDII system 306 and other such diagnostics systems, detect diagnostic vehicle events and errors related to vehicle conditions and output codes (herein referred to as raw OBDII data) representing the errors and events when they occur. The GPS system 308 is in communication with one or more satellites to determine the current location of the vehicle and generate vehicle location data, such as latitude and longitude.

The video system 310 includes one or more video capturing devices, such as video cameras, which generate images of views around the vehicle. Many other vehicle systems in addition to those shown in FIG. 3 may communicate with the vehicle-based computer 300. The vehicle-based computer 300 includes an OBDII interface 312, a GPS interface 312, and a video interface 316 that interface with the OBDII system 306, the GPS system 308, and the video system 310, respectively.

The OBDII interface 312 interfaces with the OBDII system 306 via a Data Link Connector (DLC), which is physical connector specified in the OBDII specification. The OBDII interface 312 retrieves the raw OBDII data in real-time from the OBDII system 306. The OBDII interface 312 may then format and store the OBDII data in the vehicle information store 302 for presentation or use with other system data. The OBDII interface 312 can also update a set of OBDII error codes and events as the OBDII standard changes. As discussed further below, the vehicle-based computer 300 can use the OBDII diagnostics codes to generate user-friendly explanations of vehicle conditions.

With regard to the GPS interface 314, location data from the GPS system 308 is received by the GPS interface 314 and formatted and stored for presentation and/or use with other vehicle system data. The GPS interface 314 may periodically store the location data in memory with a timestamp obtained from a clock in the vehicle-based computer 300. The GPS interface 314 can update map information, including Geographic Information System (GIS) data, which can be provided by the server application 304. One particular application that can serve as the GPS interface 314 is MAPPOINT by MICROSOFT Corporation. Other GPS/GIS applications, besides MAPPOINT, may be used for the GPS interface 314.

The video interface 316 receives image data from the video system 310 and stores the image data in the vehicle information store 302. The image data may be stored with a timestamp for later retrieval and/or association with other vehicle system data. The amount of image data that can be store may depend on the amount of memory available in the vehicle information store 302, and is typically implementation specific.

Other vehicle systems 318 are other vehicle systems that may generate or use data during operation. For example, the other vehicle systems 318 can include a vehicle security system, an obstacle detection system, media systems, vehicle environment systems (e.g., temperature control), and sound systems. Other interfaces 320 are provided as necessary for interfacing with other vehicle systems 318. Other interfaces 320 receive data from and send data to other vehicle systems 318. Data received from other vehicle systems 318 may be stored in the vehicle information store 302, and later processed and presented to a user.

One or more of the vehicle systems 306, 308, 310, and/or 318, or their corresponding interfaces may be configurable. For example, a media system in the other systems 318 may be configured with a list of music selections. As another example, the GPS system 308 and/or the GPS interface 314 may be configured with updated map, GIS, or satellite data. Such configuration data may be received from a network and updated in memory, such as the vehicle information store 302. The configuration data may also be downloaded from a magnetic disk, a memory card, or other memory device. When configuration data is received for a particular lo vehicle system, the appropriate interface updates the vehicle system or interface.

The vehicle information store 302 includes a repository for information from one or more vehicle systems. One implementation of the vehicle information store 302 includes a relational database. As shown, the vehicle information store 302 includes, but is not limited to, memory associated with each of the vehicle systems shown in FIG. 3. User profiles 322 is a repository for user profile information pertaining to user preferred settings. Thus, for example, user profile information in the user profiles 322 may be indexable by user name or user identifier. Media 324 includes media data that can be presented on a local or remote client device. Exemplary media include musical tracks, other audio, and video.

A maintenance log 326 includes a history of vehicle maintenance. For example, oil changes, repairs, and other vehicle maintenance may be recorded in the maintenance log 326. Diagnostics explanations 328 include graphical and textual explanations of diagnostics conditions identified by OBDII errors and events. Because many users may not be experts in car diagnostics, the graphical and textual explanations are provided to explain OBDII errors and events, preferably in terms that are readily understandable by a layperson. When an OBDII error or event is detected, associated graphical and/or textual explanations can be retrieved from the diagnostics explanations 328 and presented to a user immediately or stored in data store for later presentation to a user.

An OBDII data store 330 is a repository for OBDII events and errors, which can be stored as errors and events as they are detected. The events and errors can be used to identify associated diagnostics explanations 328 for presentation to a user. The stored errors and events in the OBDII data store 330 can also be related to GPS locations and/or map data that are stored in a GPS/map data store 332. Thus, for example, a map can be presented with a marker where a particular OBDII error or event was detected.

Video storage 334 is a repository for video images captured by the video source 310. As discussed above, the video interface 316 can store captured video image data in the video storage 334. Video images in the video storage 334 can be presented on a display device connected to the vehicle-based computer 300 and/or a display device connected to a client computer in communication with the vehicle-based computer 300. Other storage 336 may be used to store any other data used by the vehicle-based computer 300. For example, other storage 336 may include data from other vehicle systems 318.

Although the vehicle information store 302 is depicted as a relational database in FIG. 3, it is to be understood that any type of memory configuration can be used to implement the vehicle information store 302. By way of example, and not limitation, the vehicle information store 302 can be implemented using a solid state memory, flash memory, and memory cards.

The server 304 provides services and interfaces to a client 304 for accessing and/or updating vehicle information storage 302. The server 304 communicates with the client 338 via a network communication port. As discussed earlier, the client 304 may be either remote or local. Exemplary local and remote clients 304 are described above with respect to FIG. 1 and FIG. 2.

The server 304 provides data according to the network protocol such that data from the vehicle can be distributed to the client 338 over the network. The server 304 presents a user interface 342 through which a user at the client 338 can interface with the server 304. One implementation of the user interface 342 is a network document, such as a web page, that is browsable by a browser application executing on the client 338. A network document includes text and/or other data organized according to a markup language that is readable by a network document reader, such as a browser. Popular network document markup languages are Hypertext Markup Language (HTML), Standard Generalized Markup Language (SGML), and Extensible Markup Language (XML).

The user interface 340 can include selectable symbols, such as hyperlinks to other web pages 342, which are also browsable by the client 338. In addition to hyperlinks, the user interface 340 and other web pages 342 can include other selectable and non-selectable symbols, such as images, graphics, text, text entry fields, and tables.

The other web pages 344 can include information from the vehicle information storage 302. The web server 304 can, for example, populate an HTML template web page with OBDII error and event codes, along with a time of each error and event code. In another implementation, the web server 304 can use an active server pages application 344 to generate the web page(s) 342. One exemplary implementation of an active server pages application 344 is ASP .NET produced by MICROSOFT Corporation. The web page(s) 342 can include embedded objects, such as Flash video clips and .NET web controls.

In addition, using an internet protocol (IP) address for the server 304, the client 338 can request data from the server 304. The server 304 may include database server functionality, by which the server 304 can query the vehicle information storage 302 to satisfy client 338 requests. The server 304 includes relational functionality whereby one type of data from the vehicle information storage 302 can be related to and presented with other types of data from the vehicle information storage 302.

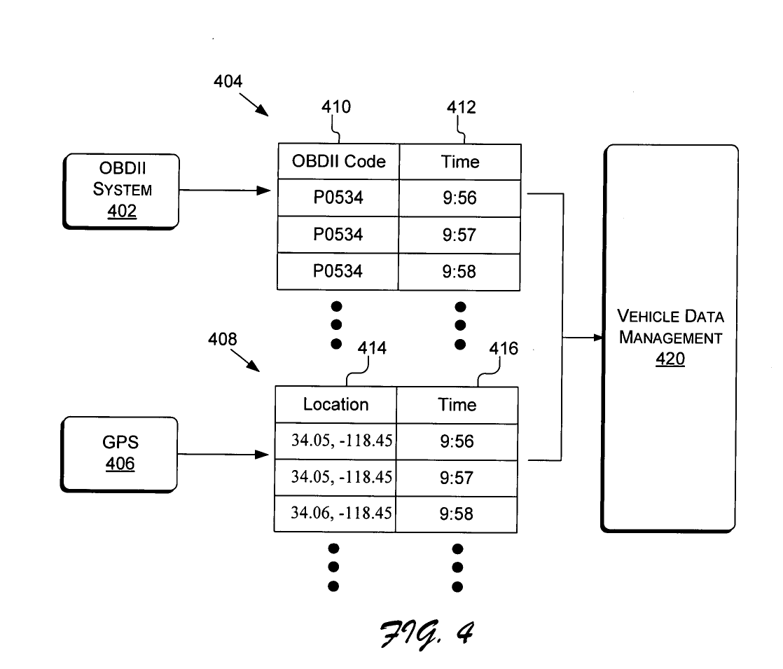

FIG. 4 illustrates an exemplary enhanced vehicle data scheme whereby data from two different vehicle systems in a vehicle can be related for presentation to a user. As shown, an on-board diagnostics (OBD) system 402 collects diagnostics data, such as events and errors and stores them in an exemplary diagnostics log 404. Also shown is a global positioning system (GPS) 406 that collects GPS data, such as position or location data, and stores them in an exemplary location log 408.

The diagnostics log 404 includes a code column 410 that includes one or more data fields for storing diagnostics codes related to events or errors that are detected by the OBD system 402 in the vehicle. The diagnostics log 404 also includes a time column 412 having data fields for storing timestamps indicating when associated diagnostics codes occurred. Thus, for example, an error having code P0534 was detected at 9:56. Diagnostics codes in the code column 410 are typically specified by a diagnostics specification, such as the OBDII standard. The diagnostics codes may be specific to the make, model, or type of vehicle. The timestamps in the time column 412 can be given in any time format, such as a twelve hour clock or twenty-four hour clock.

The location log 408 includes a location column 414 and a time column 416. The location column 414 has data fields for storing location information gathered by the GPS 406. The time column 416 includes data fields for storing timestamps indicating when the vehicle was at the locations in the location column 414. The location data in the location column 414 may be in any geographic data format, such as minutes and seconds, or decimal. As shown in FIG. 4, the exemplary location data specifies latitude and longitude in a decimal format (e.g., 34.05, −118.45).

A vehicle data management module 420 can read the data from the diagnostics log 404 and the location log 408 and create relationships between the location data and the diagnostics data. For example, the vehicle data management module 420 can determine the location of the vehicle when a particular vehicle error occurred. As illustrated, the error code P0534 occurred at 9:56 when the vehicle was located at 34.05, −118.45. The vehicle data management module 420 can associate a location with a code and transmit the location to a mapping application. The mapping application can present a marker on a map at the location to indicate where a particular diagnostics error was detected. The vehicle data management module 420 can be implemented with a relational database software application.

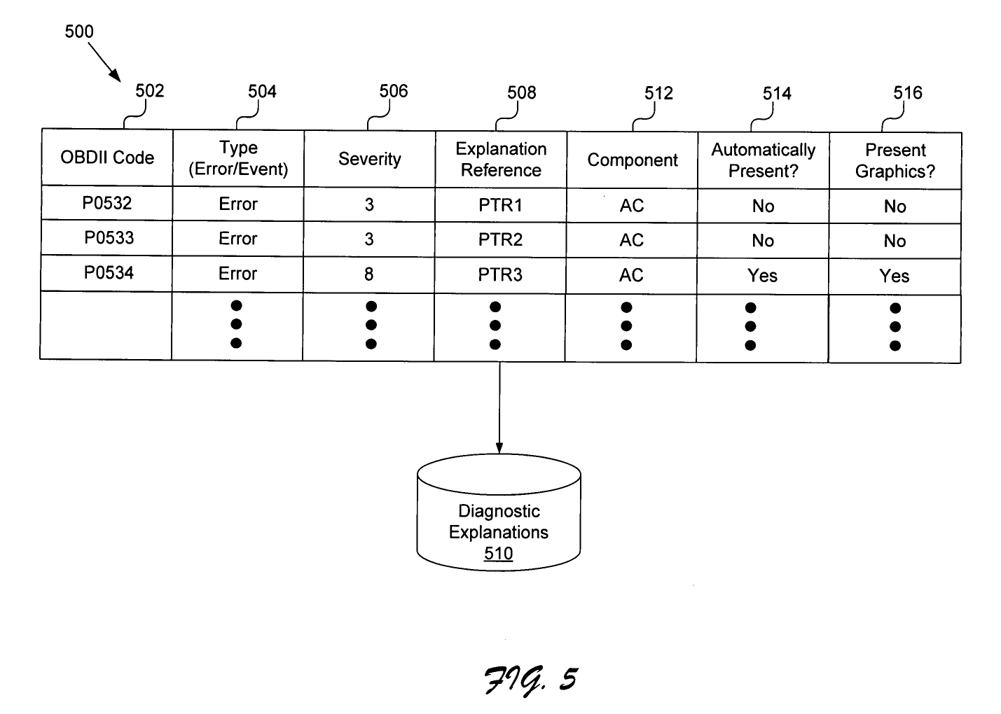

FIG. 5 illustrates an exemplary enhanced vehicle data scheme whereby diagnostics data can be used to generate explanatory information for presentation to a user. The explanatory information can be text, graphical, or other information that describes associated diagnostics codes. The explanatory information can beneficially be presented to a driver or other occupant of the vehicle or the explanatory information can be presented to a remote user. The explanatory information may be presented in a real-time fashion or some time after the information is generated.

A diagnostics information registry 500 includes a number of associations between various vehicle diagnostics data. The diagnostics information registry 500 is configured in advance, typically by populating the registry 500 with relevant vehicle diagnostics codes and the information related to those codes for the type, make, and/or model of the vehicle. The diagnostics information registry 500 can be updated with different or additional information as vehicle diagnostics codes change.

A vehicle diagnostics code column 502 includes vehicle diagnostics codes, such as the vehicle diagnostics codes specified in the onboard diagnostics code II (OBDII) standard. A vehicle diagnostics code is a set of one or more symbols that identifies a vehicle condition. Each vehicle make and model typically has a set of vehicle diagnostics codes. A type column 504 includes data fields indicating the type of the vehicle diagnostics code. For the OBDII standard, the types of codes are either ‘error’ or ‘event’. Other types of vehicle diagnostics codes may be stored in the type column 504.

A severity column 506 includes data fields storing a severity levels, or seriousness, of conditions associated with the vehicle diagnostics codes. The severity levels may be configured in various ways. For example, a “low, medium, high” format can be used. FIG. 5 illustrates a scheme in which severity levels range from 1-10, wherein a value of 10 indicates a more serious condition. The severity levels may be generated automatically or by a user, such as a mechanic or driver.

Thus, one user may consider a particular condition to be more serious than another user. For example, a user in Arizona may associate a high severity level with air-conditioning error codes, whereas a user in Michigan may associate a lower severity level with air-conditioning codes. As another example, the severity level may be increased when a particular condition is expected to occurring in order to diagnose a problem. The severity levels can be used to trigger presentation of an explanation or other visible or audible indicator to a user.

An explanation reference column 508 includes data fields with references (e.g., handles, pointers, keys, indices, etc.) to an explanations store 510 that includes explanations of the vehicle conditions corresponding to the vehicle diagnostics codes. The explanations include user-friendly explanations that are easily understandable by a typical vehicle owner. The explanations store 510 includes explanations in one or more formats including, but not limited to, textual, graphical, or audible explanations of the vehicle diagnostics codes. The explanations in the explanations store 510 are updateable. As such, new, different, or additional explanations may be stored in the explanations store 510.

One implementation of the explanation reference column 508 stores memory pointers into the explanation store 510. Thus, for example, ‘PTR3’ may be a memory pointer that references a memory location in the explanations store 510, where a graphical image of a vehicle component associated with the diagnostics code ‘P0534’ is stored. ‘PTR3’ may also reference a textual description of the error associated with the diagnostics code ‘P0534’. ‘PTR3’ can also be an index or key in the database of the explanations 510.

The diagnostics information registry 500 and the explanations store 510 could be located on a vehicle-based computer and/or on a remote computer. In one implementation, the vehicle-based computer can be accessed remotely to request full explanation of the problem or OBD code only. In another implementation, the OBD code can be transmitted to a remote computer, which accesses an explanations store at the remote computer, or on some other computer on the network.

In another implementation of the explanations store 510, supplemental information is stored that is related to the vehicle diagnostics codes. Supplemental information includes any other useful information that may further assist a vehicle owner in diagnosing, repairing, or understanding a condition related to a vehicle diagnostics code. For example, the explanations store 510 can include estimated prices for components or services to repair a faulty condition in the vehicle. As another example, the explanations store 510 can include a list of dealerships to which the vehicle owner could bring the vehicle for service.

A component column 512 has data fields to store component identifiers identifying components associated with the vehicle diagnostics codes. Thus, for example, the component associated with vehicle diagnostics code ‘P0532’ is the air conditioning (AC) unit.

An automatic presentation column 514 has data fields to store indicators of whether to automatically present explanatory data when the associated vehicle diagnostics codes are detected. The automatic presentation data fields can be a Boolean indicator. Alternatively, the automatic presentation data fields may be a function of the severity levels in the severity column 506. For example, the automatic presentation column 514 can include a severity level for each code, such that explanatory data will only be shown if a detected code has a higher severity.

In some implementations, processor power or display device capabilities may not be sufficient to satisfactorily display explanatory graphics, such as image data. In such implementations a user may choose not to present graphics explanations. A present images column 516 includes indicator fields to indicate whether images or other explanatory graphics should be presented when an associate diagnostics code is detected. In one implementation, the present images column 516 includes Boolean values indicating whether graphics should be shown.

The diagnostics information registry 500 may be used by a vehicle-based computer when a vehicle condition (e.g., error or event) is detected to inform a user of the condition. When the condition is detected, an associated diagnostics code is looked up in the information registry 500. An associated memory reference from the explanation reference column 508 can be used to retrieve an explanation of the condition from the diagnostics explanations store 510. The retrieved explanation may be stored or automatically presented to a user on a display device or other output device. Other information, such as the severity level associated with the detected condition and the vehicle component can also be presented.

Although the diagnostics log 404 (FIG. 4), the location log 408 (FIG. 4), and the diagnostics information registry 500 (FIG. 5), are illustrated as relational tables, it is to be understood that the actual data need not be stored or manipulated in a table format. For example, in a particular implementation, an Application Specific Integrated Circuit (ASIC) may be used that has inputs for vehicle diagnostic codes and hardware mappings to one or more of the pieces of data shown in FIG. 4 or FIG. 5. In another implementation, software data structures, such as linked lists, objects, or others, can be used to create relations between vehicle system data and other useful data.

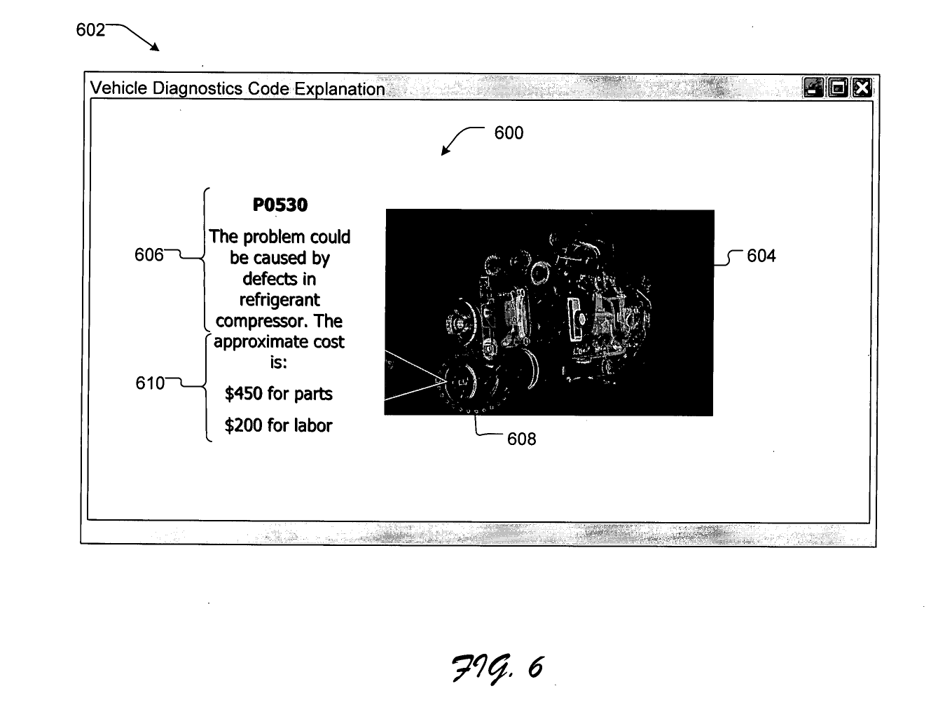

FIG. 6 illustrates an exemplary explanation 600 of a vehicle condition based on a vehicle diagnostics code. The exemplary explanation 600 is displayed in a window 602 that may be generated by a browser application. As illustrated, the vehicle diagnostics code ‘P0530’ is being explained. The explanation 600 includes a graphical portion 604 and a text explanation 606 is illustrated in the window.

The text explanation 606 briefly describes the likely affected vehicle component. The graphical portion 604 includes a graphical image, such as a Joint Photographic Experts Group (JPEG) or a Graphics Interchange Format (GIF) formatted image. The video portion could be represented by WMV, MPEG, AVI and other standards. The audio portion can be stored as WMA, MP3 and other standards. In the graphical portion 604 of the explanation 600, a marker 608 is shown around a vehicle component related to the vehicle condition. Supplemental data 610 is presented along with the text explanation 606. As illustrated, the supplemental data 610 includes estimated cost of parts and labor to repair the compressor.

Exemplary Operations

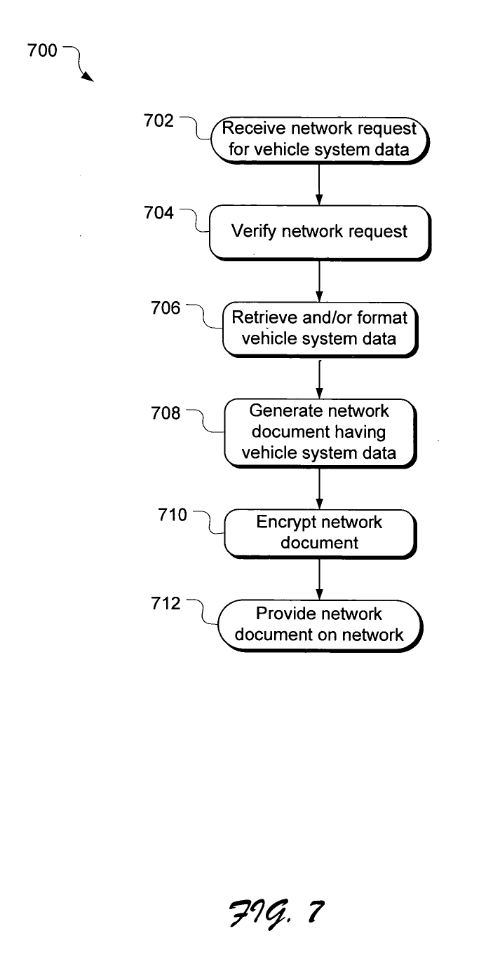

FIG. 7 is an operation flow 700 having exemplary operations the may be performed by a vehicle-based computer for remotely managing vehicle systems in a vehicle. The exemplary operations in the operation flow 700 may be performed periodically while the vehicle is being operated. While the exemplary operations are illustrated in a particular sequence in FIG. 7, it is to be understood that the exemplary operations can be performed in other sequences other than the sequence shown in FIG. 7, depending on the particular implementation.

Prior to the operation flow 700, it is assumed that vehicle system data has been gathered from one or more vehicle systems. Gathering vehicle system data involves requesting vehicle system data from the one or more vehicle systems in real-time. The vehicle system data may be formatted and/or stored in a memory in the vehicle-based computer where the data is accessible to subsequent operations in the operation flow 700.

A receiving operation 702 receives a network request for at least a subset of the vehicle system data and/or enhanced vehicle event information. The network request may come from a remote client or a local client. The request is typically is formatted according to a network protocol such as a TCP/IP or HTTP protocol, and has a network identifier (e.g., and Internet Protocol (IP) address) associated with the vehicle-based computer. The receiving operation 702 recognizes the request as being directed to the vehicle-based computer, decodes the request, and identifies which vehicle system data is being requested. The receiving operation 702 is optional.

If a network request is received for vehicle system data and/or enhanced vehicle event information, a verifying operation 704 verifies the validity of the network request. In one implementation of the verifying operation 704, the network request is decrypted. Verifying may also involve validating the identity of the requesting client.

The retrieving operation 706 retrieves vehicle system data and/or enhanced vehicle system data from memory. The retrieving operation 706 may retrieve “standard” vehicle system data of predetermined types. For example, the vehicle-based computer may automatically retrieve all OBD codes so that the OBD codes can be presented to a user. Alternatively, the retrieving operation 706 may retrieve data in response to the receiving operation 702, whereby the specifically requested data is retrieved.

The generating operation 708 generates one or more network documents, such as web pages, that include subsets of the vehicle system data and/or enhanced vehicle event data. The generating operation 708 may generate “standard” network documents with predetermined subsets of the vehicle system data. Alternatively, or in addition, the generating operation 708 may generate one or more network documents with requested vehicle system data or enhanced vehicle event information specified in a network request received in the receiving operation 706.

One implementation of the generating operation 608 involves using a common gateway interface (CGI) to dynamically generate a hypertext markup language (HTML) web page having vehicle system data. The vehicle system data included in the HTML web page can be a predetermined subset of the vehicle system data that was gathered from the vehicle systems. Alternatively, the vehicle system data included in the HTML can be selected based on a network request for the data.

Another implementation of the generating operation 608 involves generating active server pages (ASP) that include the vehicle system data. An ASP application may enable more variation in the types of vehicle system data that are presented in the web page, as well as more flexibility in the presentation format of the vehicle system data.

An encrypting operation 710 encrypts the generated network document to achieve some level of information security. Examples of encrypting algorithms that may be employed by the encrypting operation 710 are data encryption standard (DES), RSA, and hashing algorithms.

A providing operation 712 makes the generated network document(s) available to network document reader applications, such as browsers. The providing operation 712 may transmit one or more network documents over the network according to the network protocol. For example, the providing operation 712 can transmit web pages over the Internet to a client where the web pages can be viewed by a browser.

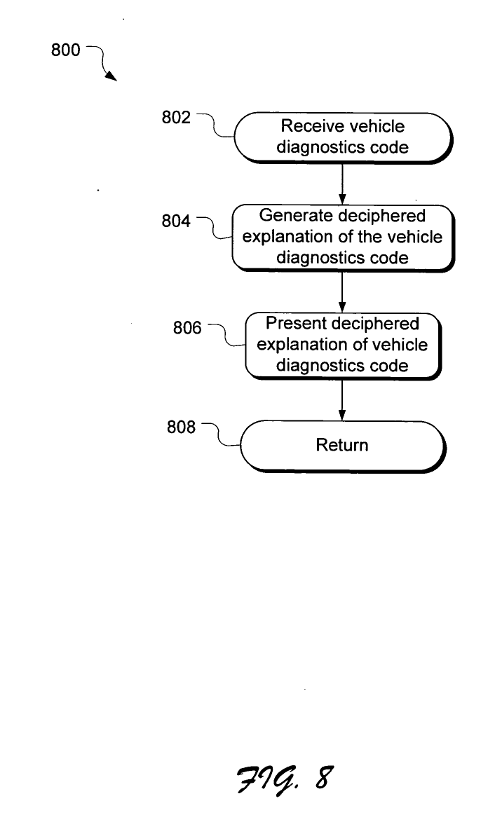

FIG. 8 illustrates a deciphering operation 800 having exemplary operations for deciphering a vehicle diagnostics code into a user-friendly explanation of a vehicle condition related to the vehicle diagnostics code. The operation 800 can be implemented in computer-executable instructions and stored on a computer-readable medium for execution by a computer, such as the vehicle-based computers described herein.

A receiving operation 802 receives a vehicle diagnostics code, such as an OBDII code, from a vehicle diagnostics system operating in a vehicle. When the vehicle diagnostics system detects a vehicle condition, such as an event, error, or fault, the vehicle diagnostics system generates a code that identifies the condition. The code is stored in a memory and/or read by a vehicle-based computer in communication with the vehicle diagnostics system. The receiving operation 802 may convert the vehicle diagnostics code into a format readable by the vehicle-based computer and/or store the diagnostics code in memory.

A generating operation 804 generates an explanation of a vehicle condition corresponding to the received vehicle diagnostics code. The generating operation 804 involves retrieving one or more explanations, including a text explanation, a graphical illustration of a vehicle component, and/or an audio explanation. One implementation of the generating operation 804 looks up the vehicle diagnostics code in a data structure, such as the diagnostics code registry shown in FIG. 5. In this implementation, a reference is obtained for a memory location where an explanation is stored.

The generating operation 804 may also retrieve supplemental data related to the condition identified by the received vehicle diagnostics code. As discussed above, supplemental data can include an estimated cost of repair and/or dealership locations.

A presenting operation 806 presents the generated explanation via a display device or other output media device. The explanation may be output to a local, vehicle-based computer or a remotely networked computer. The presenting operation 806 may involve generating a web page in a markup language, such as hypertext markup language (HTML), whereby the deciphered explanation may be browsed by a browsing application. The presenting operation 806 may also present a timestamp, location, severity level, a code type, a component identifier, or other data related to the vehicle diagnostics codes. The deciphering operation 800 ends at return operation 808.

Exemplary Computer System that May be Used to Implement a Vehicle Information System

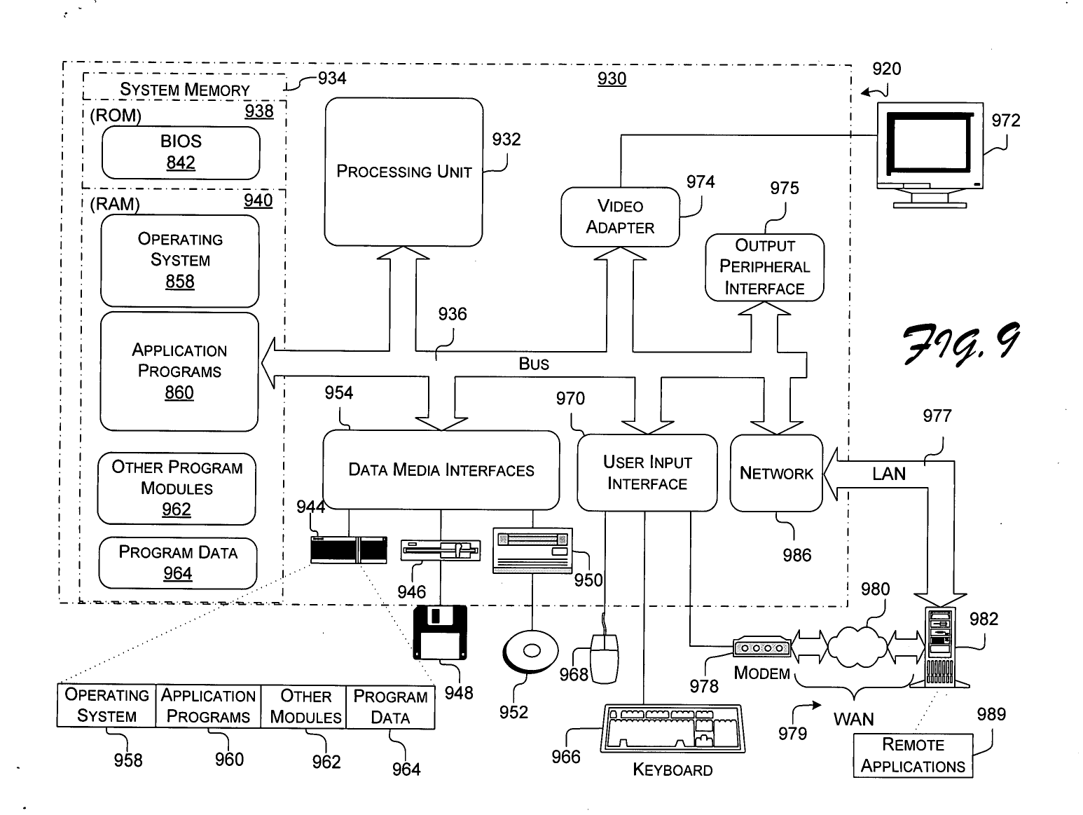

FIG. 9 and the corresponding discussion are intended to provide a general description of a suitable computing environment in which the described arrangements and procedures for presenting vehicle information may be implemented. Exemplary computing environment 920 is only one example of a suitable computing environment and is not intended to suggest any limitation as to the scope of use or functionality of the described subject matter. Neither should the computing environment 920 be interpreted as having any dependency or Is requirement relating to any one or combination of components illustrated in the exemplary computing environment 920.

The exemplary arrangements and procedures to transport computer data between interconnected devices are operational with numerous other general purpose or special purpose computing system environments or configurations. Examples of well known computing systems, environments, and/or configurations that may be suitable for use with the described subject matter include, but are not limited to, personal computers, server computers, thin clients, thick clients, hand-held or laptop devices, multiprocessor systems, microprocessor-based systems, mainframe computers, distributed computing environments such as server farms and corporate intranets, and the like, that include any of the above systems or devices.

The computing environment 920 includes a general-purpose computing device in the form of a computer 930. The computer 930 may include and/or serve as an exemplary implementation of a vehicle-based computer for presenting enhanced vehicle event information described above with reference to FIGS. 1-8. The components of the computer 930 may include, by are not limited to, one or more processors or processing units 932, a system memory 934, and a bus 936 that couples various system components including the system memory 934 to the processor 932.

The bus 936 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

The computer 930 typically includes a variety of computer readable media. Such media may be any available media that is accessible by the computer 930, and it includes both volatile and non-volatile media, removable and non-removable media.

The system memory includes computer readable media in the form of volatile memory, such as random access memory (RAM) 940, and/or non-volatile memory, such as read only memory (ROM) 938. A basic input/output system (BIOS) 942, containing the basic routines that help to communicate information between elements within the computer 930, such as during start-up, is stored in ROM 938. The RAM 940 typically contains data and/or program modules that are immediately accessible to and/or presently be operated on by the processor 932.

The computer 930 may further include other removable/non-removable, volatile/non-volatile computer storage media. By way of example only, FIG. 9 illustrates a hard disk drive 944 for reading from and writing to a non-removable, non-volatile magnetic media (not shown and typically called a “hard drive”), a magnetic disk drive 946 for reading from and writing to a removable, non-volatile magnetic disk 948 (e.g., a “floppy disk”), and an optical disk drive 950 for reading from or writing to a removable, non-volatile optical disk 952 such as a CD-ROM, DVD-ROM or other optical media. The hard disk drive 944, magnetic disk drive 946, and optical disk drive 950 are each connected to bus 936 by one or more interfaces 954.

The drives and their associated computer-readable media provide nonvolatile storage of computer readable instructions, data structures, program modules, and other data for the computer 930. Although the exemplary environment described herein employs a hard disk, a removable magnetic disk 948 and a removable optical disk 952, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 948, optical disk 952, ROM 938, or RAM 940, including, by way of example, and not limitation, an operating system 958, one or more application programs 960, other program modules 962, and program data 964. Application programs 960 may include an enhanced vehicle system information application for generating enhanced vehicle system information as discussed herein.

A user may enter commands and information into the computer 930 through optional input devices such as a touch screen display mounted on monitor 972, a keyboard 966 and a pointing device 968 (such as a “mouse”). Other input devices (not shown) may include a microphone, joystick, game pad, satellite dish, serial port, scanner, or the like. These and other input devices are connected to the processing unit 932 through a user input interface 970 that is coupled to the bus 936, but may be connected by other interface and bus structures, such as a parallel port, game port, a universal serial bus (USB), or wirelessly.

An optional monitor 972 or other type of display device is connected to the bus 936 via an interface, such as a video adapter 974. In addition to the monitor, personal computers typically include other peripheral output devices (not shown), such as speakers and printers, which may be connected through output peripheral interface 975.

The computer 930 may operate in a networked environment using logical connections to one or more remote computers, such as a remote computer 982. The remote computer 982 may include many or all of the elements and features described herein relative to the computer 930. The logical connections shown in FIG. 9 are a local area network (LAN) 977 and a general wide area network (WAN) 979. The LAN 977 and/or the WAN 979 can be wired networks, wireless networks, or any combination of wired or wireless networks. Such networking environments are commonplace in offices, enterprise-wide computer networks, intranets, and the Internet.

When used in a LAN networking environment, the computer 930 is connected to the LAN 977 via a network interface or an adapter 986. The network interface 986 provides communications services for transmitting and receiving data to and from one or more clients. For example, the network interface 986 formats, encodes, modulates, demodulates, and decrypts data communicated via the LAN 977. The network interface 986 operably communicates over a network using a network communication protocol. Examples of communications devices suitable for the network interface 986 include a cellular modem, Wireless Fidelity (WiFi), other wireless communications devices, as well as Ethernet, FireWire, and other wired technologies.

When used in a WAN networking environment, the computer 930 typically includes a network adapter or network card 978 or other means for establishing communications over the WAN 979. The network card 978, which may be internal or external, may be connected to the system bus 936 via the user input interface 970 or other appropriate mechanism. Depicted in FIG. 9 is a specific implementation of a WAN via the Internet. The computer 930 typically includes a network card 978 or other means for establishing communications over the Internet 980. The network card 978 is connected to the bus 936 via the interface 970.

In a networked environment, program modules depicted relative to the personal computer 930, or portions thereof, may be stored in a remote memory storage device. By way of example, and not limitation, FIG. 9 illustrates remote application programs 989 as residing on a memory device of remote computer 982. It will be appreciated that the network connections shown and described are exemplary and other means of establishing a communications link between the computers may be used.

Although some exemplary methods, devices and exemplary systems have been illustrated in the accompanying drawings and described in the foregoing detailed description, it will be understood that the methods and systems are not limited to the exemplary embodiments disclosed, but are capable of numerous rearrangements, modifications and substitutions without departing from the spirit set forth and defined by the following claims.

1. A method comprising:
generating an explanation of a vehicle condition based on a vehicle diagnostics code comprising a set of symbols.

2. A method as recited in claim 1 wherein the generating operation comprises retrieving a textual explanation of the vehicle diagnostics code.

3. A method as recited in claim 1 wherein the generating operation comprises retrieving a graphical illustration of a component associated with the vehicle diagnostics code.

4. A method as recited in claim 1 further comprising generating supplemental information related to the vehicle diagnostics code.

5. A method as recited in claim 4 wherein the generating supplemental information operation comprises retrieving an estimated price for repairing a condition related to the vehicle diagnostics code.

6. A method as recited in claim 4 wherein the generating supplemental information operation comprises retrieving a location of a vehicle dealership.

7. A method as recited in claim 1 further comprising presenting the explanation at a client computer.

8. A method as recited in claim 7 wherein the presenting operation comprises presenting the explanation at a local, vehicle-based client.

9. A method as recited in claim 7 wherein the presenting operation comprises presenting the explanation at a remote client.

10. A method as recited in claim 1 further comprising storing an updated explanation of the vehicle condition in a memory.

11. A method as recited in claim 1 further comprising transmitting the vehicle diagnostics code to a remote computer.

12. A computer-readable medium having stored thereon a computer program having executable instructions for performing a process comprising generating a deciphered explanation of a vehicle diagnostics code.

13. A computer-readable medium as recited in claim 12 wherein the generating operation comprises generating a textual explanation of the vehicle diagnostics code.

14. A computer-readable medium as recited in claim 12 wherein the generating operation comprises generating a graphical illustration of a component associated with the vehicle diagnostics code.

15. A computer-readable medium as recited in claim 12, the process further comprising generating supplemental information related to the vehicle diagnostics code.

16. A computer-readable medium as recited in claim 15 wherein the generating supplemental information operation comprises generating an estimated price for repairing a condition related to the vehicle diagnostics code.

17. A computer-readable medium as recited in claim 15 wherein the generating supplemental information operation comprises generating a location of a vehicle dealership.

18. A computer-readable medium as recited in claim 12, the process further comprising presenting the deciphered explanation at a client computer.

19. A computer-readable medium as recited in claim 18 wherein the presenting operation comprises presenting the deciphered explanation at a local, vehicle-based client

20. A computer-readable medium as recited in claim 18 wherein the presenting operation comprises presenting the deciphered explanation at a remote client.

21. A computer-readable medium as recited in claim 12, the process further comprising updating the deciphered explanation of the vehicle diagnostics code.

22. A computer-readable medium as recited in claim 12, the process further comprising:
transmitting the vehicle diagnostics code to a remote computer;
looking up the deciphered explanation in an explanations store in operable communication with the remote computer, the explanations store having one or more explanations associated with one or more associated diagnostics codes.

23. A vehicle comprising a computer generating a deciphered explanation of a vehicle diagnostics code.

24. A vehicle as recited in claim 23, wherein the deciphered explanation comprises a textual explanation of the vehicle diagnostics code.

25. A vehicle as recited in claim 23, wherein the deciphered explanation comprises a graphical illustration of a component associated with the vehicle diagnostics code.

26. A vehicle as recited in claim 23, wherein the computer is further operable to generate supplemental information related to the vehicle diagnostics code.

27. A vehicle as recited in claim 26, wherein the supplemental information comprises an estimated price for repairing a condition related to the vehicle diagnostics code.

28. A vehicle as recited in claim 26 wherein the supplemental information comprises a location of a vehicle dealership.

29. A vehicle as recited in claim 23 further comprising a display device presenting the deciphered explanation.

30. A vehicle as recited in claim 23, further comprising an audio output device presenting an audio version of the deciphered explanation.

31. A vehicle as recited in claim 29, wherein the computer transmits the deciphered explanation to a remote client computer for presentation at the remote client.

32. A vehicle as recited in claim 23, wherein the computer comprises an updateable repository of one or more deciphered explanations associated with one or more vehicle diagnostics codes.

33. A vehicle-based system comprising:
a diagnostics receiver module receiving a vehicle diagnostics code from a vehicle diagnostics system, the vehicle diagnostics code including a set of one or more symbols and corresponding to a vehicle condition;
means for generating an explanation of the vehicle condition based on the vehicle diagnostics code.

34. A vehicle-based system as recited in claim 33 wherein the means for generating comprises a computer-readable memory storing a diagnostics information registry having a field storing a reference to the explanation.

35. A vehicle-based system as recited in claim 33 wherein the means for generating comprises a memory storing explanations of one or more predetermined vehicle diagnostics codes.

36. A vehicle-based system as recited in claim 35 wherein the memory stores one or more of a graphical explanation, a textual explanation, and an audio explanation.

37. A vehicle-based system as recited in claim 33 further comprising a network communications module communicating the explanation over a network.

38. A vehicle-based system as recited in claim 33 further comprising a media output device presenting the explanation.

39. A vehicle-based system as recited in claim 38 wherein the media output device comprises audio speakers outputting an audio explanation.

40. A vehicle-based system as recited in claim 34 further comprising an update module updating information in the diagnostics information registry.

41. A vehicle-based system as recited in claim 34 wherein the diagnostics information registry comprises:
a severity field storing a severity level associated with the vehicle condition;
a component field storing a component identifier associated with the vehicle condition;
a type field storing a diagnostics code type associated with the vehicle diagnostics code;
an automatic field storing an indicator indicating whether to automatically present the explanation;
an graphics field storing an indicator indicating whether to present graphics data included in the explanation.

42. A vehicle-based system as recited in claim 33 wherein the vehicle diagnostics code is an onboard diagnostics II (OBDII) code.

43. A method comprising:
receiving a vehicle diagnostics code from a vehicle diagnostics system, the vehicle diagnostics code including a set of one or more symbols and corresponding to a vehicle condition;
retrieving an explanation of the vehicle condition based on the vehicle diagnostics code.

44. A method as recited in claim 43 wherein the retrieving operation comprises accessing a memory location storing an updateable explanation.

45. A method as recited in claim 44 further comprising updating the explanation.

46. A method as recited in claim 43 further comprising presenting the explanation automatically in response to receiving the vehicle diagnostics code.

47. A method as recited in claim 43 further comprising presenting the explanation in response to a request from a user.

48. A method as recited in claim 43 further comprising communicating the explanation over a network.
